(19) United States
(12) Patent Application Publication
(10) Pub. No.: US 2005/0045212 A1
(43) Pub. Date: Mar. 3, 2005

(54) Method of, and apparatus for, dissolving crude oil sludge

(76) Inventor: William Benjamin Howe, Cheltenham (GB)

Correspondence Address: YOUNG & THOMPSON, 745 SOUTH 23RD STREET, 2ND FLOOR, ARLINGTON, VA, 22202, US

(21) Appl. No.: 10/497,308

(22) PCT Filed: Nov. 28, 2002
(86) PCT No.: PCT/GB02/05370

(30) Foreign Application Priority Data
Nov. 30, 2001 (GB) 0128707.7
Feb. 14, 2002 (GB) 0203465.0

(51) Int. Cl. B08B 9/00

(52) U.S. Cl. 134/22.1

(57) ABSTRACT

The method includes the steps of pumping solvent under pressure into the mass of sludge, pumping the resultant mixture of solvent and dissolved sludge into the remaining mass of sludge until all or substantially all of the sludge is dissolved to a pumpable viscosity, pumping the dissolved sludge from the containment, and monitoring and controlling the aforementioned steps remotely. Apparatus for performing the method is also disclosed. This includes elements for pumping the solvent and dissolved sludge mixture into the remaining mass of sludge, elements for removing the dissolved sludge from the containment, elements for supporting and transporting the pumping elements through the dissolved sludge mixture and elements for monitoring and controlling the apparatus remotely.

This invention relates to a method of, and apparatus for, dissolving crude oil sludge held in containments such as bulk storage tanks or tankers or holes in the ground.

As crude oil becomes more viscous it can coalesce into what is generally referred to as sludge. The sludge represents value to its owner if it can be dissolved and incorporated into the owner's income-earning activities. Where sludge is contained in a receptacle such as a storage or settlement tank, the recovery of such sludge can be a hazardous operation particularly if operatives are required to wear full breathing and safety equipment to be able to enter the tank in order to spray dissolving-fluid at the sludge. As man-way entry/exit points of storage tanks are of limited dimension the apparatus is capable of being packed in a foldaway form to facilitate egress through such entry/exit points and unfolded into its operating mode after entry into the area to be worked on.

Conventionally sludge is removed from tanks by a variety of methods which range from digging it out to pumping water or chemicals under pressure to create an emulsion which is then pumped out and disposed of. There are significant disadvantages to these methods which the present invention seeks to overcome. The disadvantages are health and safety, environmental and economic. Health and safety, because of the need for operatives to work in tanks. Environmental because if the crude oil sludge cannot be recovered for use then it has to be disposed of in an environmentally friendly way. Economic because the sludge represents value if the value of the sludge can be released and also whilst the sludge is in the tank it takes up valuable space.

Further, in order to clean the inside of tanks for, say, inspection, repair or change of use cleaning devices, referred to as spinners, are used which, because of their method of construction, do not allow for them to be operated at other than the speed designed by the factory setting. That “one model fits all” approach has limitations as it means that the cleaning operation inputs—such as solvent or cleaning fluid and cleaning medium—and outputs—such as effluent—all have a cost which could be more easily controlled if the speed of operation could be accurately tailored to the job. To overcome this disadvantage and to be able to obtain the desired economies in operation apparatus to be specified can be deployed in such environments.

According to one aspect of the present invention there is provided a method of dissolving crude oil sludge in a containment, comprising the steps of:
a. pumping solvent under pressure into the mass of sludge.
b. pumping the resulting mixture of solvent and dissolved sludge into the remaining mass of sludge until all or substantially all of the sludge is dissolved to a pumpable viscosity,
c. pumping the dissolved sludge from the containment, and
d. monitoring and controlling the above steps remotely.

Preferred and/or optional features of the first aspect of the invention are set out in claims 2 to 4.

According to another aspect of the present invention there is provided apparatus for performing the method according to the first aspect of the invention, comprising means for pumping the solvent and dissolved sludge mixture into the remaining mass of sludge, means for removing the dissolved sludge from the containment, means for supporting and transporting the pumping means through the dissolved sludge mixture and means for monitoring and controlling the apparatus remotely.

Preferred and/or optional features of said another aspect of the invention are set out in claims 6 to 10.

The preferred solvent is formulated from derivatives of orange oils and a synthesized mineral oil, such as Pronatur Orange Solvent made by Orapi S.A. of 12 Rue Pierre Mendes, 69511 Vaulx en Velin, Cedex, Lyon, France. When this solvent is pumped into sludge the sludge appears to dissolve immediately. The amount of solvent required depends on three factors, the pour-point temperature of the sludge, the % of wax contained in the sludge, and the maximum acceptable viscosity of dissolved sludge.

Preferably, the apparatus comprises a multi-nozzled rotor or spinner. The angle at which the nozzles are set can be varied in order to obtain optimum working of a particular rotor or spinner in a particular tank. Also, preferably, there is provided a means of stopping the flow of cleaning fluid through one or more nozzles in order to allow the same basic rotor or spinner design to be usable in open-topped containers as well as enclosed containers and to avoid drenching the apparatus under the path of the jets of solvent or cleaning fluid which would otherwise flow through the nozzles as the rotor or spinner rotates.

A preferred embodiment of the apparatus is summarized as a multi-nozzled rotor or spinner which is releasably secured to a pump and driven by a flow of solvent or solvent and dissolved sludge mixture or cleaning fluid pumped under pressure from the pump. The pump may be either releasably secured to a raft, tractor or sump-cone lowered onto the floor of the containment or as part of clean-in-place (CIP) setting to the tank to be cleaned or external to the tank—depending on circumstances applying at site of operation—so that the force of the solvent or solvent and dissolving sludge mixture or cleaning fluid delivered through outlet nozzles located at specific points and angles on, along or around the circumference of a rotor block or outlet pipes attached to the rotor block causes the rotor block to rotate in a controlled manner. The provision of a releasably secured collar or shoulder within the rotor block enables the directional flow through certain nozzles to be restricted or stopped for operational needs, such as being able to clean open-topped containers or to avoid drenching the apparatus under the path of the jets of solvent or cleaning fluid which would otherwise flow through the nozzles as the rotor or spinner rotates. The solvent is used to dissolve the un-dissolved sludge it comes into contact with and also causes the rotor or spinner to rotate in a controlled manner to increase the area of sludge to be dissolved. On a modified rotor block the rotor or spinner can be transformed into a paddle-wheel by the attachment of transverse flats to the rim of the rotor block which when properly located on the raft and activated by solenoid switches is used to assist propulsion of the raft through the dissolved sludge in addition to sludge pumped directly to create such propulsion. Lights and a CCTV camera releasably secured to the raft, tractor or sump-cone illuminate and survey the area of sludge being dissolved and observe obstructions or other impediments to progress. Sensors may be provided for obtaining trigonometric readings to pin-point the location of the raft in tank. The raft may have several releasably connected floats to provide buoyancy to support the weight of the equipment. The tractor may have wheels or caterpillar tracks powered by an electric motor. A control box may be provided with appropriate software and means of two-way electrical or electronic communication with the different pieces of equipment to control the operation of the apparatus and ancillary equipment and devices such as generators, compressors, pumps, CCTV recording and play-back equipment as may be necessary to support the use of the apparatus when in operating conditions.

The invention will now be more particularly described, by way of example, with reference to the accompanying drawings in which:

FIG. 1 shows one embodiment of apparatus in operating mode when attached to a raft.

FIG. 2 shows another embodiment according to the invention in operating mode when attached to a tractor.

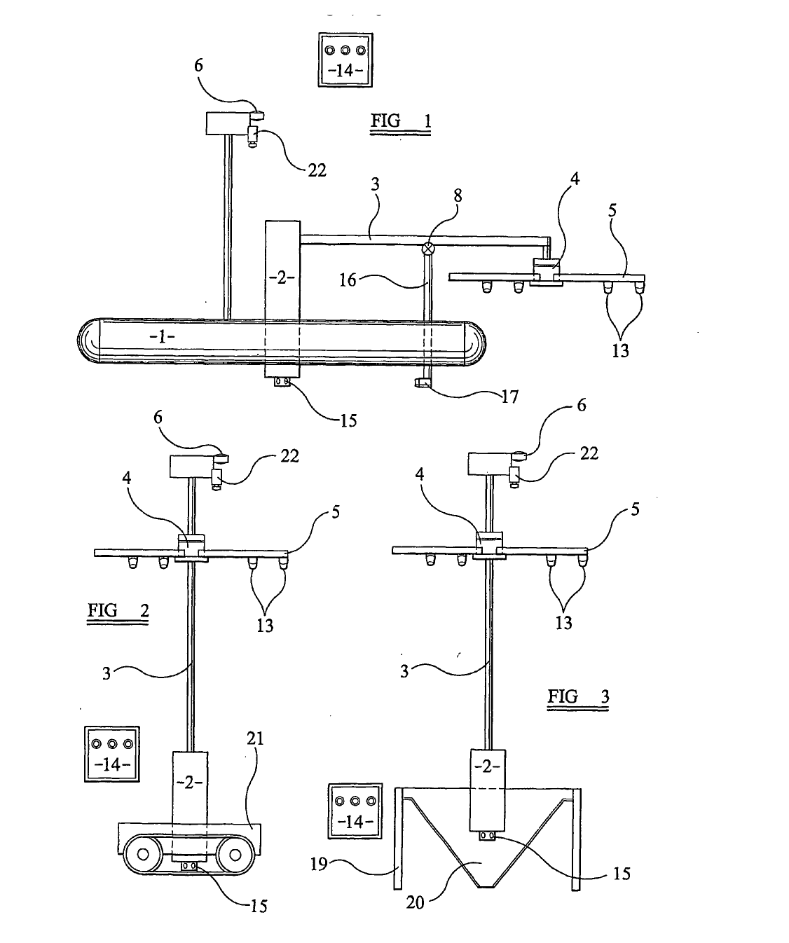

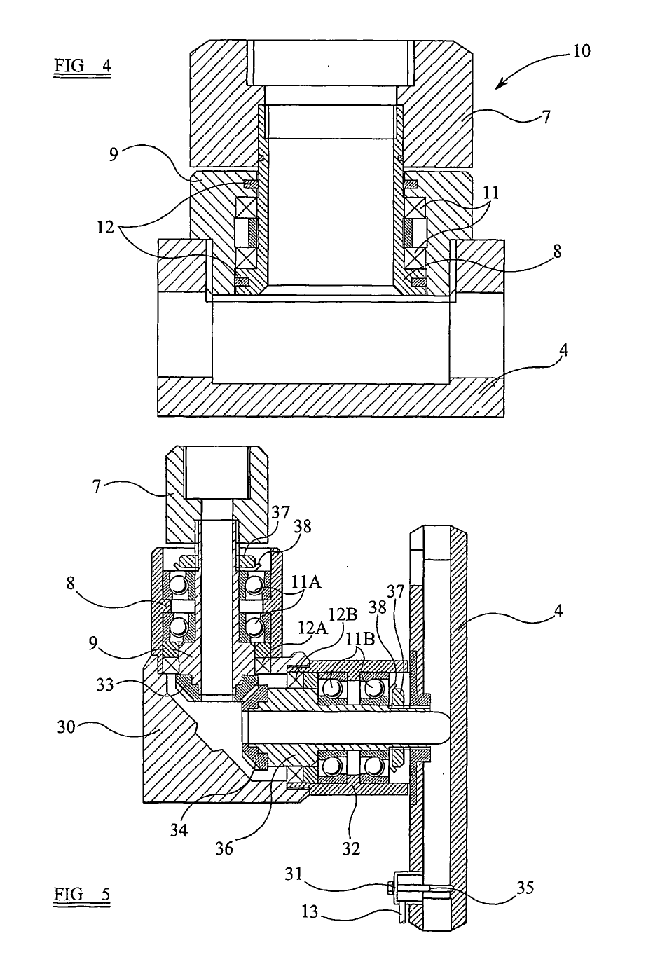

FIG. 3 shows yet another embodiment in operating mode when attached to a sump-cone.

FIG. 4 shows the rotor block of the apparatus of FIGS. 1, 2 and 3.

FIG. 5 shows details of the spinner assembly of yet a further embodiment the apparatus.

FIG. 6 shows a modification to threaded rotor/drive connection to create a “shoulder”.

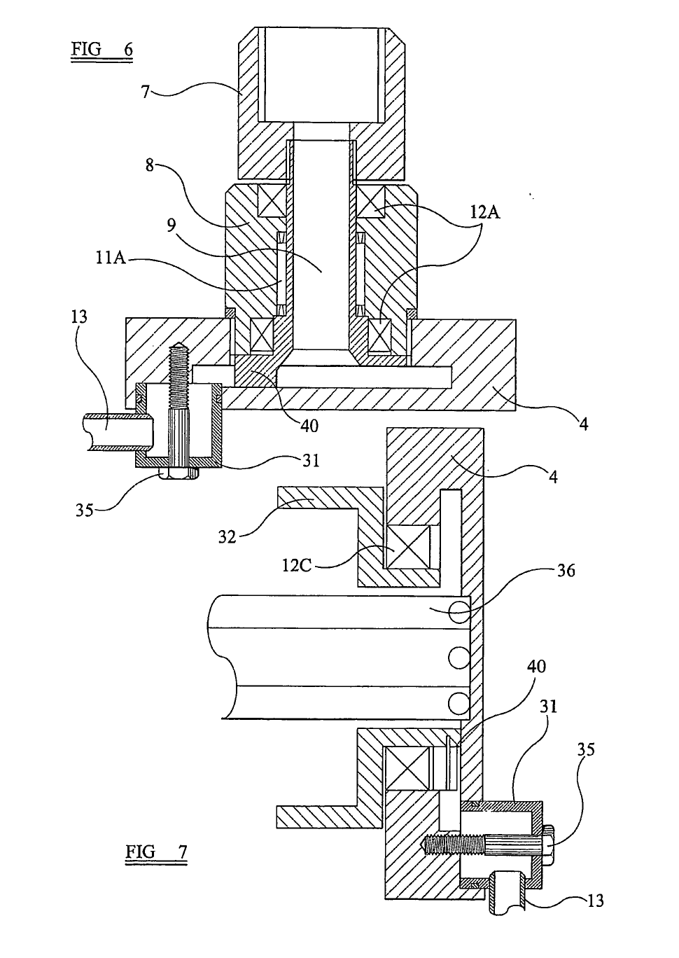

FIG. 7 shows another modification to threaded rotor connection to create a “shoulder”.

Referring to the drawings the apparatus shown therein comprises buoyancy floats 1 (FIG. 1) or a tractor 21 (FIG. 2) or a sump-cone 20 (FIG. 3), a pump 2 connected by a flow-pipe 3 to a rotor comprising a rotor block 4 and a plurality of radially outwardly extending arms 5 releasably connected to the rotor block 4, CCTV camera 22 and lights 6; all releasably connected by, for example, flexible joints, circlips, unions or similar means (not shown). At convenient points on the raft 1, tractor 21 or sump-cone 20, cleats or similar devices (not shown) are fitted to facilitate securing or manoeuvring the apparatus by ropes or similar means (not shown).

As shown in FIG. 4, the rotor block 4 is connected to the flow-pipe 3 by an inlet assembly 10 which comprises a threaded inlet nut 7, a threaded inlet-nut stop 8 and a threaded rotor connection 9, bearings 11 supporting the rotor connection 9 on the inlet-nut stop 8, and seals 12. The threaded rotor connection 9 joins the inlet assembly 10 to the rotor block 4 from which the arms 5 extend.

Each arm 5 carries one or preferably, as shown, a plurality of nozzles 13. The nozzles 13 are inclined to the vertical in order to propel the rotor when solvent is pumped through the arms 5 and the nozzles 13 by the pump 2. The number of nozzles 13 or the position of the nozzles 13 on the arms 5 or the angle of inclination of the nozzles 13 can be varied to vary the speed of the rotation of the rotor and to provide a spray pattern which provides the greatest contact with the sludge to be dissolved.

FIG. 5 shows an alternative rotor (or spinner) comprising a disc-shaped rotor block 4 and a plurality of nozzles 13 circumferentially spaced apart on the block 4.

The nozzles 13 are releasably connected to the rotor block 4 by threaded connections. This allows nozzles 13 with an appropriate orifice size to be selected to accommodate a desired flow rate and to provide a desired speed of rotation. The number of nozzles 13 or the angle of inclination of each nozzle 13 to a diametral plane through the rotor block 4 can also be varied to vary the speed of rotation of the rotor. Each nozzle has a cap 31 releasably attached to the rotor block 4 by a screw or bolt 35. The rotor block 4 is supported by a mounting comprising an angle connector 30 having an inlet and an outlet, an inlet assembly connected to the inlet of the connector 30 and an outlet assembly connected to the outlet of the connector 30. The inlet assembly comprises a collar 8 threadably connected to the inlet of the connector 30, a rotor/drive connection 9 which is threadably connected to a drive nut 7 and which is rotatably supported by bearings 11A mounted in the collar 8, seal 12A, washer 38 and locking nut 37. The outlet assembly comprises a collar 32 threadably connected to the outlet of the connector 30, a rotor connection 36 which is threadably connected to the rotor block 4 and which is rotatably supported by bearings 11B mounted in collar 32, seal 12B, washer 38 and a locking nut 37. The rotor/drive connection 9 includes a bevel gear 33 to mesh with a bevel gear 34 attached to the rotor connection 36 to allow the rotary action of the rotor 4 to be transmitted to a different plane from the drive nut 7.

FIG. 6 shows a setting in which the rotor 4 is connected directly to the collar 8 and the rotor/drive connection 9 is extended and profiled to create a shoulder 40 to allow one or more nozzles 13 to be closed off sequentially as the rotor 4 rotates.

FIG. 7 shows a setting in which the rotor 4 is connected directly to the rotor connection 36 and the collar 32 is profiled to allow a shoulder 40 to be releasably attached to allow one or more nozzles 13 to be closed off sequentially as the rotor 4 rotates.

Controls 14 to stop/start and monitor operations are maintained outside the tank but releasably connected to the apparatus and other equipment being used. The control box and associated software is typical of CIP control equipment used in the dairy industry.

The method for using the apparatus will now be described envisaging
A. a circumstance in which buoyancy from a raft is desirable,
B. a circumstance in which the use of a tractor or similar means of propulsion is desirable,
C. a circumstance in which a static location is desirable,
D. for cleaning the walls and bottom of an open-topped tank or use as a paddle-wheel,
E. for cleaning all surfaces of an enclosed tank,
F. for cleaning either the bottoms of tanks or inside surface of a pipeline.

In each case sufficient solvent will need to be pumped into the tank to create a pool of solvent and sludge in order to prime and operate the pump used with the apparatus. Thus, with circumstance A, after a pool of dissolved sludge is created, the raft and attached apparatus as shown in FIG. 1 is placed in that pool; the pump 2 is then in a position to suck the dissolved sludge in through inlet port 15 of the pump and force it along pipe 3 to the rotor block 4, along the spray arms 5 and out through the nozzles 13. The combined force and flow of solvent and dissolved sludge through the nozzles 13 causes more crude to dissolve thus increasing the size of the pool of dissolved sludge. As the pool size increases the raft will need to be moved in order to maintain contact with undissolved sludge. This movement is obtained from the thrust derived by diverting via valve 18 dissolved sludge from flow pipe 3 along pipe 16 to an outlet port 17, at which port may be located a rotor or spinner modified as a paddle-wheel to provide propulsion when the diverted sludge causes this paddle-wheel to rotate. The viscosity of the pool of dissolved sludge can be maintained by adding more solvent using an externally located pump (not shown) and by using an agitating mechanism such as a slow-speed propeller (not shown) located in the pool to cause the dissolved sludge to circulate. When the pool of solvent has reached the desired viscosity required by the owner—as measured by in-line Viscometer (not shown)—it can be removed either by pumping it directly from the tank, or indirectly by pumping sufficient water into the tank to allow the oil to be floated out of the tank through outlet ports in the wall of the tank into appropriate recovery vessels. In the event that the apparatus needs to be recovered, the raft 1 has ropes attached to cleats (not shown) and connected to a winch (not shown) located outside the tank in order to winch the raft and apparatus to safety.

Whilst the apparatus is in operation the sludge being dissolved can be illuminated by lights 6 so that human operators located outside the tank can observe the operations via the CCTV camera 22 connected to a monitor screen (not shown) and control operations with the control box 14.

With circumstance B, after a pool of dissolved sludge is created, the tractor 21 and attached apparatus as shown in FIG. 2 is placed in that pool; the pump 2 is then in a position to suck the dissolved sludge in through inlet port 15 and force it along pipe 3 to the rotor block 4 along the spray arms 5 and out through the nozzles 13. The combined force and flow of solvent and dissolved sludge through the nozzles 13 causes more crude to dissolve thus increasing the size of the pool of dissolved sludge. As the pool size increases the apparatus will need to be moved in order to maintain contact with undissolved sludge. This movement is obtained by using an electric-motor powered tractor 21 which has been approved for use in this environment. The viscosity of the pool of dissolved sludge can be maintained by adding more solvent using an externally located pump (not shown) and by using an agitating mechanism such as a slow-speed propeller (not shown) located in the pool to cause the dissolved sludge to circulate. When the pool of solvent has reached the desired viscosity required by the owner—as measured by an in-line Viscometer (not shown)—it can be removed either by pumping it directly from the tank, or indirectly by pumping sufficient water into the tank to allow the oil to be floated out of the tank through the outlet ports in the wall of the tank into appropriate recovery vessels. In the event that the apparatus needs to be recovered, the tractor 21 has ropes attached to cleats (not shown) and connected to a winch (not shown) located outside the tank in order to winch the tractor and apparatus to safety.

Whilst the apparatus is in operation the sludge being dissolved can be illuminated by lights 6 so that human operators located outside the tank can observe the operations via the CCTV camera 22 connected to a monitor screen (not shown) and control operations with the control box 14.

With circumstance C, a pool of sludge needs to be created in a different fashion where the sludge is of such a depth that entrance into the tank through a man-way in the side wall is not desirable or not possible and where entrance is only possible through the roof or floating membrane covering the sludge. In this case it may be first necessary to lower through a man-way a sump-cone 20 as shown in FIG. 3 which, because of its weight, will sink into the sludge and have the effect of allowing a pool of solvent and solvent sludge mixture to accumulate in the sump-cone 20 in order that the pump 2 can operate. The sump-cone 20 is supported by legs 19 and is in the shape of an inverted truncated cone with means for lowering/lifting it (not shown) and releasably securing (not shown) the pump 2 inside the space contained by the skin of the cone. After a pool of solvent or dissolved sludge is created in the sump-cone 20, the pump 2 is then in a position to suck the dissolved sludge in through inlet port 15 and force it along pipe 3 to the rotor block 4 along the spray arms 5 and out through the nozzles 13. The combined force and flow of solvent and dissolved sludge through the nozzles 13 causes more crude to dissolve thus increasing the size of the pool of dissolved sludge. The viscosity of the pool of dissolved sludge can be maintained by adding more solvent using an externally located pump (not shown) and by using an agitating mechanism such as a slow-speed propeller (not shown) located in the pool to cause the dissolved sludge to circulate. As the pool depth increases some of the dissolved sludge will need to be pumped out of the tank in order to allow the remaining sludge to settle into the space created. This process will then continue until such time that it is possible to deploy the apparatus attached to a raft 1 as described in Circumstance A. When the pool of solvent has reached the desired viscosity required by the owner—as measured by an in-line Viscometer (not shown)—it can be removed either by pumping it directly from the tank, or indirectly—when the side-wall man-ways are accessible—by pumping sufficient water into the tank to allow the oil to be floated out of the tank through such outlet ports in the wall of the tank into appropriate recovery vessels.

Whilst the apparatus is in operation the sludge being dissolved can be illuminated by lights 6 in order that human operators located outside the tank can observe the operations via the CCTV camera 22 connected to a monitor screen (not shown) and control operations with the control box 14.

The raft 1 is conveniently assembled from connectable plastics or other strong light-weight materials to provide sufficient buoyancy for the weight of the raft and its equipment and capable of being easily assembled after entry into and disassembled before egress from storage/settlement tank through a man-way. The tractor 21 is driven by an electric motor similar to tractors used in gas pipelines and as such warranted suitable for use in an explosive environment.

The pumping mechanism comprises pump 2 and rotor block 4 with spray arms 5 or nozzles 13 through which the solvent and sludge mixture is delivered and includes connecting pipework 3 and 16 and valve 18. The pump 2 is of a type suitable for hazardous environments. The rotor block 4 and the spray arms 5 have nozzles 13 to create flat jets so that as the rotor block 4 rotates the kinetic energy derived from the force of the jets of solvent and solvent-sludge mixture delivered through the nozzles 13 accelerates the dissolution of the sludge. The pump 2 operates at a convenient pressure up to 5 Bar and the nozzles 13 will accommodate the flow rate delivered by the pump 2. Rotation of the rotor block 4 is achieved by the flow of fluid through the nozzles 13 and the speed of rotation is determined by the location of the nozzles 13.

The control and monitoring of the operations is achieved by mounting the CCTV camera 22 and lights 6 on the raft 1, tractor 21 or sump-cone 20 and a control module 14 to stop or start the different functions involved with pumping, moving, scanning, recording, locating, measuring is connected electronically to the apparatus but located outside the tank.

The apparatus described above can also be used to clean any residue and scale from the tank, after the sludge has been dissolved. In this case, a dilute acid solution is pumped through the apparatus by the pump 2.

With circumstance D to clean the walls and bottom of an open-topped tank or use as a paddle-wheel when transverse flats (not shown) have been added to the rim of the rotor block 4, the flow of fluid through some of the spray nozzles 13 will need to be stopped as the rotor block 4 rotates. This is achieved by ensuring that a shoulder 40 of appropriate dimension is releasably attached to or formed as part of the collar 32 and that the complete assembly is appropriately positioned in the tank to ensure the spray jet leaving spray nozzle 13 reaches the desired height up the wall of the tank. Thus, with a correctly positioned shoulder 40, fluid to nozzles 13 will be sequentially blocked as the outlet to nozzle cap 31 passes behind shoulder 40. As rotor block 4 rotates the flow through spray nozzle 13 is reinstated as the outlet to spray nozzle 13 clears shoulder 40. With more than one spray nozzle 13 rotation of rotor block 4 can be maintained providing the force from flow of fluid through unmasked spray nozzles 13 is sufficient to overcome the frictional resistance of the complete unit. The speed of rotation is determined by the direction of the jet of cleaning fluid leaving spray nozzle 13. There is no rotation when nozzle 13, screw 35 and centre point of rotor 4 are in a straight line (0 degrees). There will be maximum rotation if the nozzle cap 31 is turned 90 degrees. An operator can set his angle of deflection—rotating the nozzle cap 31—between 0 degrees and 90 degrees to suit his operating requirement above the frictional resistance of the complete unit.

With circumstance E, to clean all surfaces of an enclosed tank cleaning fluid will need to flow through all of the spray nozzles 13 as the rotor block 4 rotates when rotor block 4 is attached to rotor connector 36. The speed of rotation is determined by the direction of the jet of cleaning fluid leaving the spray nozzles 13. There will be no rotation when nozzle 13, screw 35 and centre point of rotor 4 lie in a common plane (0 degrees). There will be maximum rotation if the nozzle cap 31 is turned through 90 degrees. An operator can set his angle of deflection—rotating the nozzle cap 31—between 0 degrees and 90 degrees to suit his operating requirement above the frictional resistance of the complete unit.

With circumstance F, to clean the bottom of a tank or inside surface of a pipeline cleaning fluid will need to flow through all of the spray nozzles 13 as the rotor block 4 rotates when rotor block 4 is attached directly to collar 8. The speed of rotation is determined by the direction of the jet of cleaning fluid leaving spray nozzle 13. There is no rotation when nozzle 13, screw 35 and centre point of rotor 4 are in a common plane (0 degrees). There will be maximum rotation if the nozzle cap 31 is turned through 90 degrees. An operator can set his angle of deflection—rotating the nozzle cap 31—between 0 degrees and 90 degrees to suit his operating requirement above the frictional resistance of the complete unit.

The oil contained in the dissolved sludge pumped from the tank as described above is preferably recovered and incorporated in the owner's oil processing/trading activities.

The methods and apparatus described above are given by way of example only and various modifications will be apparent to persons skilled in the art without departing from the scope of the invention as defined by the appended claims.

1. A method of dissolving crude oil sludge in a containment, comprising the steps of:
a. pumping solvent under pressure into the mass of sludge,
b pumping the resulting mixture of solvent and dissolved sludge into the remaining mass of sludge until all or substantially all of the sludge is dissolved to a pumpable viscosity,
c. pumping the dissolved sludge from the containment, and
d. monitoring and controlling the above steps remotely.

2. A method as claimed in claim 1, wherein step B. is carried out on a continuous basis until all or substantially all of the sludge is dissolved to a pumpable viscosity.

3. A method as claimed in claim 1, wherein the oil in the dissolved sludge pumped from the containment is then recovered.

4. A method, as claimed in claim 1, comprising the further step of cleaning the containment by pumping a dilute acid solution into the containment.

5. A method as claimed in claim 1, wherein the solvent is formulated from derivatives of orange oils and a synthesised mineral oil.

6. Apparatus for performing the method as claimed in claim 1, comprising means for pumping the solvent and dissolved sludge mixture into the remaining mass of sludge, means for removing the dissolved sludge from the containment, means for supporting and transporting the pumping means through the dissolved sludge mixture and means for monitoring and controlling the apparatus remotely.

7. Apparatus as claimed in claim 6, wherein the means for pumping the solvent and dissolved sludge mixture into the remaining mass of sludge comprises a pump and a rotor having a plurality of outlet for nozzles through which the solvent and dissolved sludge mixture are directed into the remaining mass of sludge.

8. Apparatus as claimed in claim 7, wherein the rotor has a plurality of angularly spaced arms each having two or more nozzles.

9. Apparatus as claimed in claim 7, wherein the rotor is disc-shaped and has a plurality of circumferentially spaced nozzles.

10. Apparatus as claimed in claim 7, wherein means are provided for sequentially restricting the flow through specific nozzles as the rotor rotates to provide a desired spreading pattern.

11. Apparatus as claimed in claim 7, further comprising valve means between the pump and the rotor to permit diversion of some of the flow in order to propel the apparatus through the dissolved sludge.

12. A method as claimed in claim 2, wherein the oil in the dissolved sludge pumped from the containment is then recovered.

13. A method, as claimed in claim 2, comprising the further step of cleaning the containment by pumping a dilute acid solution into the containment.

14. A method as claimed in claim 2, wherein the solvent is formulated from derivatives of orange oils and a synthesised mineral oil.

15. Apparatus as claimed in claim 8, wherein means are provided for sequentially restricting the flow through specific nozzles as the rotor rotates to provide a desired spreading pattern.

16. Apparatus as claimed in claim 9, wherein means are provided for sequentially restricting the flow through specific nozzles as the rotor rotates to provide a desired spreading pattern.

17. Apparatus as claimed in claim 8, further comprising valve means between the pump and the rotor to permit diversion of some of the flow in order to propel the apparatus through the dissolved sludge.

18. Apparatus as claimed in claim 9, further comprising valve means between the pump and the rotor to permit diversion of some of the flow in order to propel the apparatus through the dissolved sludge.

19. Apparatus as claimed in claim 10, further comprising valve means between the pump and the rotor to permit diversion of some of the flow in order to propel the apparatus through the dissolved sludge.
